(19) United States
(12) Patent Application Publication
(10) Pub. No.: US 2009/0300598 A1
(43) Pub. Date: Dec. 3, 2009

(54) Apparatus for transmitting software of broadcast receiver and apparatus and method for downloading software of broadcast receiver

(76) Inventor: Hyun Sik Choi, Seoul (KR)

Correspondence Address: MCKENNA LONG & ALDRIDGE LLP, 1900 K STREET, NW, WASHINGTON, DC, 20006, US

(21) Appl. No.: 12/385,886

(22) Filed: Apr. 22, 2009

(30) Foreign Application Priority Data
Apr. 23, 2008 (KR) 10-2008-0037838

(51) Int. Cl. G06F 9/445

(52) U.S. Cl. 717/173; 717/178

(57) ABSTRACT

A broadcast transmitter, a broadcast receiver and a method of receiving software of the broadcast receiver are disclosed. The method of receiving the software of the broadcast receiver includes receiving software download code information, checking a software download mode based on download mode information included in the received software download code information, requesting input of a download selection command to a user if the download mode information is a user selection mode, and determining whether or not the download of the software is started based on the download selection command received from the user.

This application claims the benefit of Korean Patent Application No. 10-2008-0037838, filed on Apr. 23, 2008, which is hereby incorporated by reference as if fully set forth herein.

### BACKGROUND OF THE INVENTION

1. Field of the Invention

The present invention relates to a broadcast receiver, a broadcast transmitter and a method of receiving software of the broadcasting receiver, and more particularly, to a broadcast receiver, a broadcast transmitter and a method of receiving software, which are capable of efficiently installing or updating software in a cable broadcast system.

2. Discussion of the Related Art

A cable broadcast is a digital broadcast based on an OpenCable Application Platform (OCAP) or Digital Video Broadcasting-Cable (DVB-C) standard, and refers to a broadcast service for manufacturing and transmitting broadcast content using a digital scheme so as to provide content with high image quality and high sound quality via a cable. Such a cable broadcast has been rapidly developed with the development of data communication technologies and user demand for content with high image quality and high sound quality. Since the digital broadcast can digitalize and process a variety of information more complicated than an analog broadcast, it is expected that the digital broadcast will play an important role in various fields such as education, medical treatment and military affairs.

A cable broadcast system for providing such a cable broadcast may be divided into a cable broadcasting station for transmitting a cable broadcast and a cable broadcast receiver for receiving the transmitted cable broadcast. Generally, the cable broadcasting station may be called a System Operator (SO) headend or a Multiple System Operator (MSO) headend. The SO refers to a cable television SO and a plurality of SOs is collectively called an MSO.

A cable headend or plant may receive a broadcast signal from a television broadcasting station via various communication networks. The cable headend transmits the cable broadcast received via the networks to a cable broadcast receiver. The cable broadcast receiver may receive or transmit a signal from or to the cable headend via a cable network capable of bi-directionally transmitting data.

The cable broadcast receiver may be of an open cable type in which a cable card including a Conditional Access (CA) system is separated from a main frame. For example, a Personal Computer Memory Card International Association (PCMCIA) card is available as the cable card. The cable card may be detachably mounted in a slot of the main frame of the cable broadcast receiver.

In the cable broadcast receiver, the main frame into which the cable card is inserted may be called a host device. For example, a digital built-in television set or a digital ready television set corresponds to the host.

The host is released as a product in a state in which adequate software is installed. The installed software refers to software for controlling an operation of the host or an operation between the host and a user, such as a user interface. Such software needs to be upgraded according to the change of a broadcast environment, in order to improve performance thereof.

### SUMMARY OF THE INVENTION

Accordingly, the present invention is directed to an apparatus for transmitting software of a broadcast receiver and an apparatus and method for downloading software of a broadcast receiver that substantially obviate one or more problems due to limitations and disadvantages of the related art.

An object of the present invention is to provide a broadcast transmitter, a broadcast receiver and a method of receiving software of the broadcast receiver, which are capable of, at the broadcast receiver, determining whether or not software is downloaded.

Another object of the present invention is to provide a broadcast transmitter, a broadcast receiver and a method of receiving software of the broadcast receiver, which are capable of, at the broadcast receiver, downloading software at a desired time of a user.

Another object of the present invention is to provide a broadcast transmitter, a broadcast receiver and a method of receiving software of the broadcast receiver, which are capable of, at the broadcast receiver, determining whether or not software is downloaded according to the characteristics and the status of the broadcast receiver.

Another object of the present invention is to provide a broadcast transmitter, a broadcast receiver and a method of receiving software of the broadcast receiver, which are capable of, at the broadcast receiver, installing software downloaded at a desired time of a user or updating the existing software using a downloaded software code.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of receiving software of a broadcast receiver, the method includes receiving software download code information, checking a software download mode based on download mode information included in the received software download code information, requesting input of a download selection command to a user if the download mode information is a user selection mode, and determining whether or not the download of the software is started based on the download selection command received from the user.

In addition, the method further includes determining whether or not the download of the software is started using a manufacturer application if the download mode information is a manufacturer selection mode. Herein, the manufacturer application determines whether or not the download of the software is started based on at least one of the number of available tuners and the number of available decoders.

In addition, the method further includes receiving the software based on the software download code information if it is determined that the download of the software is started. Herein, the receiving of the software includes receiving the software based on reception locator information included in the software download code information. Also, the receiving of the software includes receiving the software in the form of a Digital Storage Media Command and Control (DSM-CC) data download formatted code file.

In addition, the method further includes requesting the input of a rebooting selection command to the user if the reception of the software is completed, and determining whether or not rebooting is performed based on the rebooting selection command received from the user.

In addition, the software download code information includes at least one of manufacturer information and hardware information.

In addition, the software download code information is transmitted in the form of a Code Version Table (CVT). Herein, the CVT includes a descriptor field including hardware version information of a host, a descriptor number field including information about the number of descriptors, and a download command field including the download mode information.

In another aspect of the present invention, there is provided a broadcast receiver includes a tuner receiving software download code information, a user interface unit displaying information or a command and receiving information or a command from a user, and a controller checking a download mode based on download mode information included in the received software download code information and controlling the download of software according to a download selection command received by the user interface unit if the checked download mode is a user selection mode.

In addition, the controller controls a manufacturer application to determine whether or not the download of the software is started if the checked download mode is a manufacturer selection mode. Herein, the manufacturer application determines whether or not the download of the software is started based on at least one of the number of available tuners and the number of available decoders.

In addition, the controller determines whether or not rebooting is performed based on a rebooting selection command received by the user interface unit if the download of the software is completed.

In addition, the software download code information includes at least one of manufacturer information and hardware information.

In addition, the software download code information is transmitted in the form of a Code Version Table (CVT). Herein, the CVT includes a descriptor field including hardware version information of a host, a descriptor number field including information about the number of descriptors, and a download command field including the download mode information.

In another aspect of the present invention, there is provided a broadcast transmitter includes a controller selecting any one of a default mode, a monitor application selection mode, a user selection mode and a manufacturer selection mode as download mode information and including the selected download mode information in software download code information and a communication unit transmitting the software download code information. Herein, the software download code information includes at least one of manufacturer information and hardware information of a broadcast receiver. Also, the controller controls the software download code information to be included in a Code Version Table (CVT) and controls the CVT to be transmitted.

In a broadcast transmitter, a broadcast receiver and a method of receiving software of the broadcast receiver according to the present invention, since the broadcast transmitter selects any one of a default mode, a monitor application selection mode, a user selection mode and a manufacturer selection mode as download mode information, includes the selected mode in software download code information and transmits the software download code information, and the broadcast receiver determines whether or not the download of the software is started based on the download mode information included in the software download code information, the broadcast receiver can determine whether or not the download of the software is performed. Therefore, since an opportunity to select a download start time point can be provided to the user, it is possible to prevent the viewing of the broadcast of the user from being interrupted due to the download of the software. In addition, it is possible to provide a manufacturer with a right for determining an appropriate download start point according to the characteristics and the status of the broadcast receiver.

In addition, since an opportunity to select whether or not rebooting is performed can be provided to the user if the download of the software is completed, it is possible to install the software downloaded at a desired time of the user or update the existing software using the downloaded software code.

In addition, since the existing default mode and monitor application selection mode are maintained, there is backward compatibility which does not have an influence on the operations of the existing broadcast receivers. In particular, it is possible to solve the existing problems in which the software is unconditionally downloaded and restarted regardless of the intention of the user or the download methods suitable for the characteristics and the current statuses of various broadcast receivers cannot be selected.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram of a cable broadcast network including a host and a cable card according to the present invention;

FIG. 2 is a view showing the format of a Broadcast Inter ORB Protocol (BIOP) message;

FIG. 3 is a conceptual diagram of a relationship between object carousel messages transmitted from a broadcast transmitter to a broadcast receiver in a cable broadcast system;

FIG. 4 is a view showing an example of a method of downloading software;

FIG. 5 is a view showing an exemplary embodiment of a Code Version Table (CVT);

FIG. 6 is a block diagram showing the configuration of an exemplary embodiment of a broadcast transmitter according to the present invention;

FIG. 7 is a block diagram showing the configuration of an exemplary embodiment of a broadcast receiver according to the present invention; and

FIG. 8 is a flowchart illustrating an exemplary embodiment of a method of receiving software of a broadcast receiver according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, the exemplary embodiments of the present invention will be described with reference to the accompanying drawings. The configuration and action of the present invention shown in the drawings and described with reference to the drawings will be described as at least one embodiment; however, the technical idea and the core configuration and action of the present invention are not limited thereto.

Terms used in the present invention should be determined in consideration of functionality of the present invention, and may be varied depending on a user's or operator's intention, or customs in the art. Some of the terms mentioned in the description of the present invention have been selected by the applicant at his or her discretion, the detailed meanings of which are described in relevant parts of the description herein. Furthermore, it is necessary that the present invention is understood, not simply by the actual terms used but by the meanings of each term lying within.

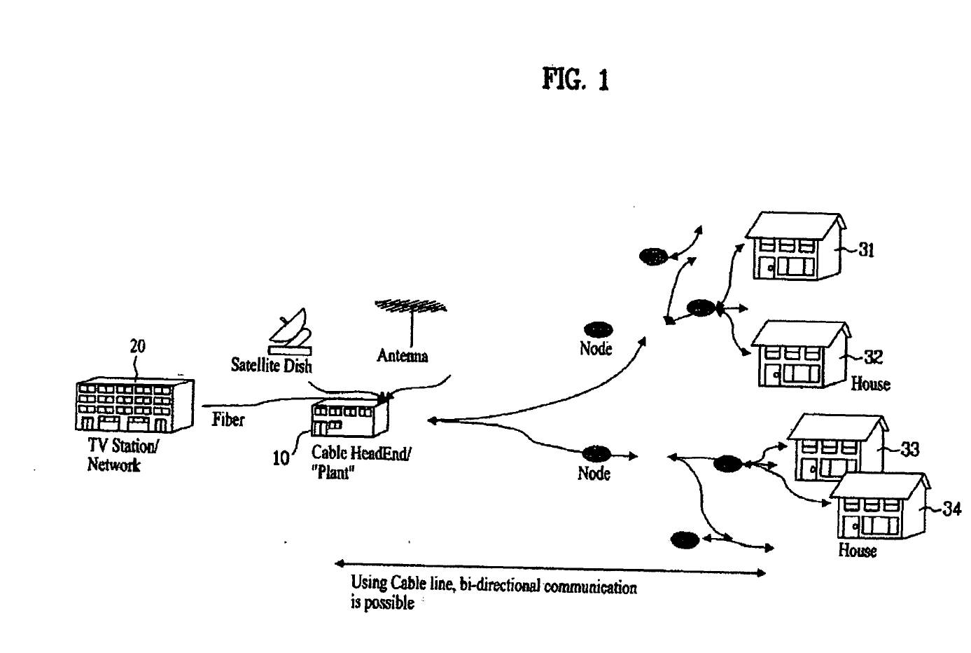

FIG. 1 is a conceptual diagram of a cable broadcast network including a host and a cable card according to the present invention.

Referring to FIG. 1, a headend/plant 10 receives a broadcast signal from a television broadcasting station 20 via a satellite or an antenna and then transmits the broadcast signal to cable broadcast receivers 31 to 34 via a cable network including nodes. In addition, the cable broadcast receiver and the headend/plant may transmit or receive a variety of data including a software code for executing a data broadcast-associated application to or from each other via a cable network infrastructure capable of bi-directionally transmitting data. The cable broadcast receiver includes a detachable cable card.

In the present invention, for example, a cable broadcast receiver which includes an Out-Of-Band (OOB) Quadrature Phase Shift Keying (QPSK) modem and a Data Over Cable Service Interface Specifications (DOCSIS) modem, and supports a DOCSIS Settop Gateway (DSG) will be described.

In addition, in the present invention, a cable broadcast receiver in which an OpenCable Application Platform (OCAP) is mounted for a bi-directional data broadcast service will be described.

The data broadcast refers to a service for utilizing the existing audio/video (A/V) broadcast (which will be also called a TV program) and a variety of supplementary information. The supplementary information may be supplementary information (e.g., a program introduction, information about players or the like) associated with the TV program which is currently being displayed, or supplementary information (e.g., news, stocks, weather, travel information or the like) which is not associated with the TV program which is currently being displayed. If a bi-directional data service can be provided, viewers can use the bi-directional service such as home shopping, home banking, games, life information, education or the like by the simple operation of a remote controller. Such a data service corresponds to an application, and is implemented using the OCAP mounted in the broadcast receiver.

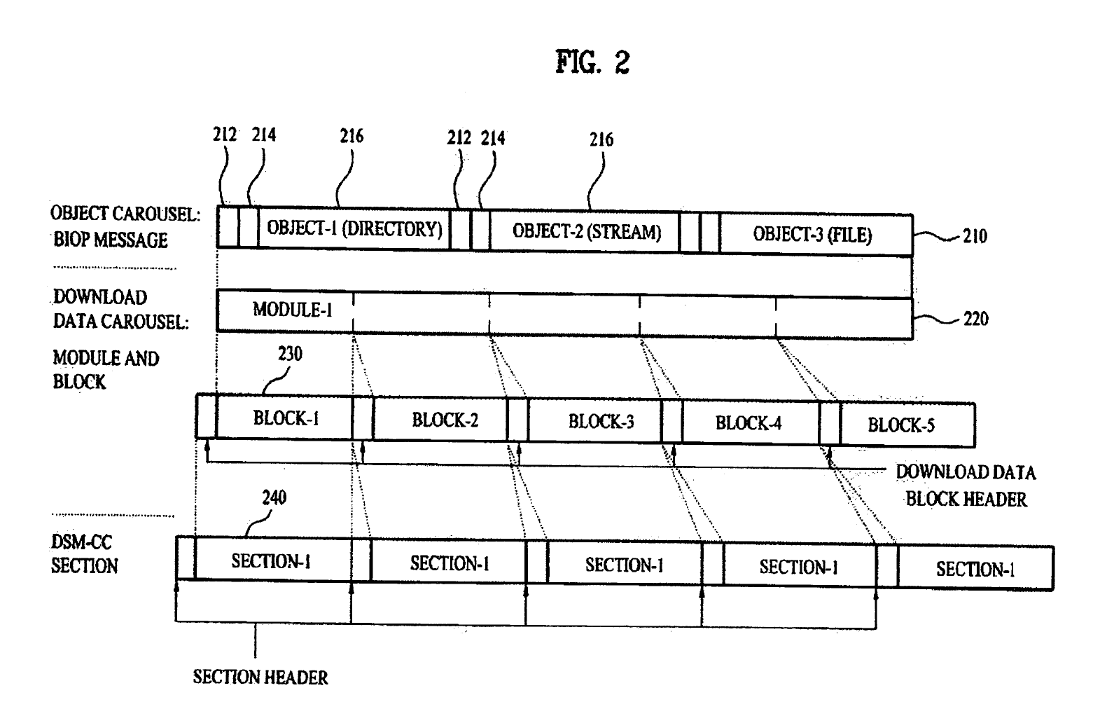

FIG. 2 is a view showing the format of a Broadcast Inter ORB Protocol (BIOP) message.

Referring to FIG. 2, the BIOP message includes a message header, a message sub-header, and a message body. The message header 212 provides information about the version of a BIOP protocol and the length of the BIOP message. The message sub-header 214 includes information about a transmitted object, such as an object type (a file, a stream or a directory) or an object key. The message body 216 includes data of an actual U-U object.

The BIOP message is broadcasted in the form of data carousel modules 220. One module 220 is formed of one or more connected BIOP messages. In the module, each object is identified by the object key. According to the Digital Storage Media Command and Control (DSM-CC) data carousel specification, each module is divided into one or more blocks. These blocks are transmitted by Download Data Block (DDB) messages 230. The DDB messages are sequentially transmitted in the form of Moving Picture Expert Group-2 (MPEG-2) sections 240. The blocks may be directly acquired from a transport stream using a hardware filter of a demultiplexer. In order to acquire one object from a broadcast network, all modules including the object should be acquired. Accordingly, the transport parameters of the module, such as a module version, a module size, a block size, a timing, a broadcast channel or the like, should be known. Since these parameters are transmitted by a Download Information Indication (DII) message, the DII message should first be acquired in order to acquire the module. As a result, a process of acquiring the object from the broadcast network includes two steps of acquiring the DII message and acquiring the module.

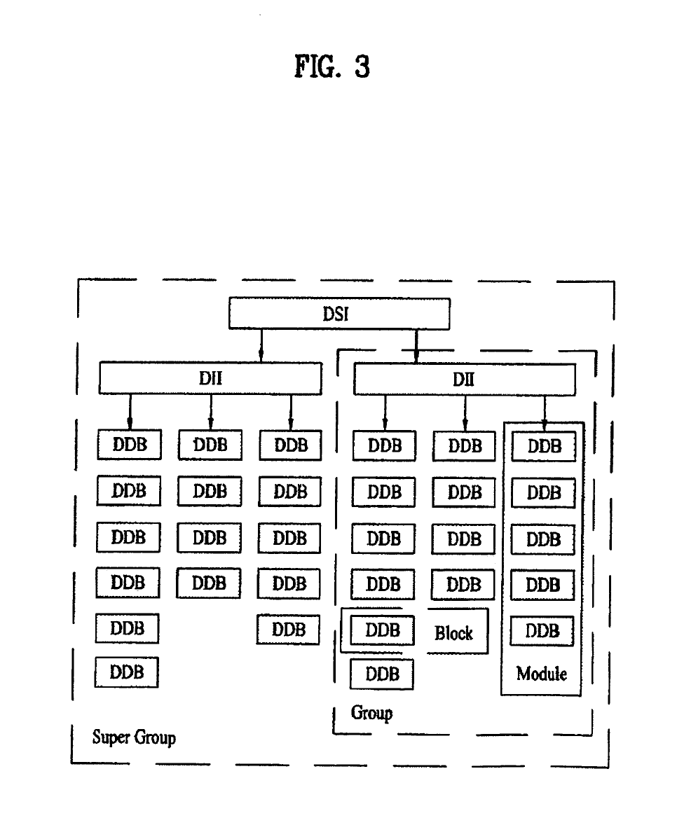

FIG. 3 is a conceptual diagram of a relationship between object carousel messages transmitted from a broadcast transmitter to a broadcast receiver in a cable broadcast system.

Referring to FIG. 3, if a cable broadcast headend transmits a software code, the software code may be transmitted in a state of being divided into one or more DDB messages. That is, each of the DDB messages is a block including a portion of one receivable software code, a plurality of DDB messages forms one module, a plurality of DDB messages or modules may configure a group by the DII message, and one or more groups may configure a super group by a Download Server Initiate (DSI) message. That is, the DSI message includes information about the groups in the super group. Accordingly, in order to download software, the DSI message may first be acquired and a service gateway information structure included in the DSI message may be then analyzed.

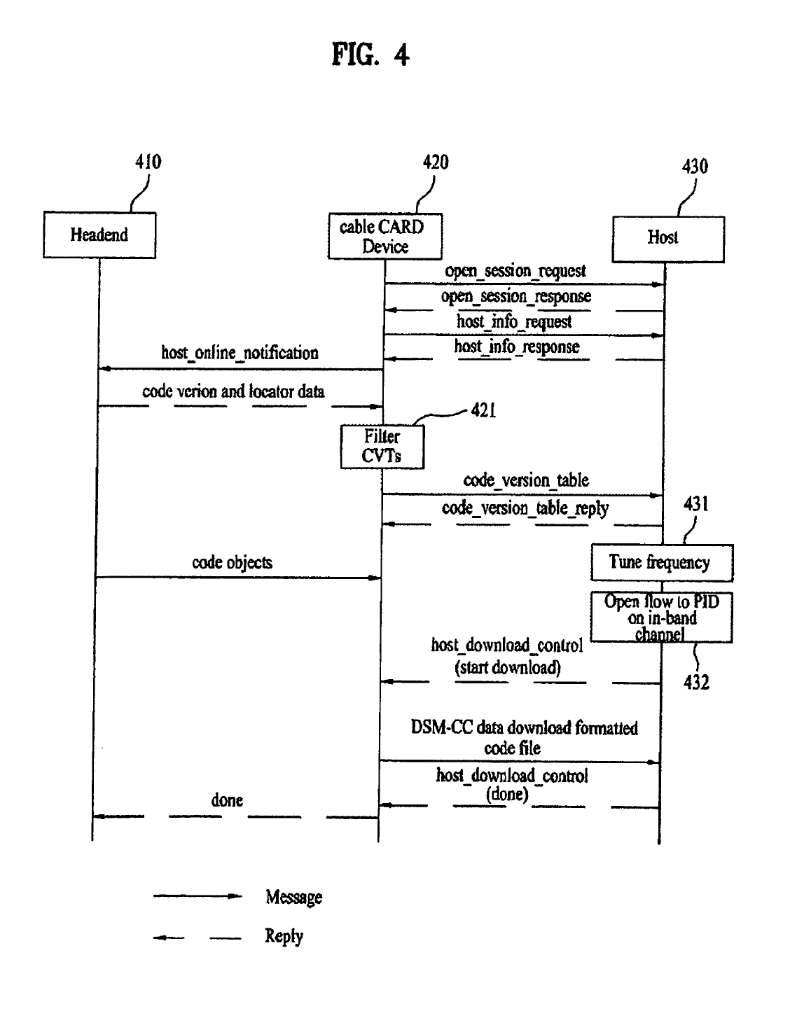

FIG. 4 is a view showing an example of a method of downloading software.

Referring to FIG. 4, when a host 430 is booted, a cable card 420 transmits an open session request (open_session_request) to the host 430. When the host 430 transmits an open session response (open_session_response), the cable card 420 transmits a host information request (host_info_request) to the host 430 and receives hardware and software information (host_info_response) from the host 430.

The cable card 420 may transmit information (host_online_notification) received from the host 430 to a headend 410. The headend 410 may determine whether or not a new software code will be transmitted to the host 430, and transmit the software code to the host 430.

For the transmission of the software code, the cable headend 410 may transmit data (code version and locator data) associated with the software code to be transmitted, such as software version information or software locator information, via a cable.

For convenience of description, hereinafter, data associated with the software code to be received by the cable broadcast receiver is referred to as software download code information. In addition, when the cable broadcast receiver receives specific information from the cable headend 410, a term “download” is used.

The software download code information may include at least one of download mode information, manufacturer information and hardware information. The download mode information is information about download mode for determining a time point when the host 430 starts download and a location where the downloaded software is applied. As the value of the download mode information, any one of a default mode, a monitor application selection mode, a user selection mode and a manufacturer selection mode is set.

If the download mode information is set to the default mode, the host 430 downloads software immediately after software download code information is received. If the download of the software is completed, the host 430 is unconditionally rebooted such that the downloaded software is applied. Since a tuner and a decoder are used for downloading the software in the process of downloading the software, the default mode for downloading the software immediately after the software download code information is received may interrupt the action of the user if a specific program is being viewed or recorded. In addition, in the default mode, since the host is unconditionally rebooted such that the downloaded software is applied, the unconditional rebooting interrupts the viewing and recording of the user.

If the download mode information is set to the monitor application selection mode, the host 430 determines whether or not the download of the software is started using a monitor application manufactured and provided by an MSO. In this case, the monitor application judges whether or not an appropriate time for downloading the software is reached, continuously waits for the appropriate time if the appropriate time is not reached, and starts the download of the software if the appropriate time is reached. If the download of the software is completed, the host 430 is rebooted such that the downloaded software is applied. Since the monitor application is collectively developed by the MSO, there is a limitation for checking and applying the number of tuners and decoders of the broadcast receiver and a specific status such as a viewing status or a recording status. Therefore, it is difficult to determine an appropriate download start time point according to the status of a specific broadcast receiver. In addition, it is impossible to determine an appropriate download start time point which does not cause inconvenience to the user.

In the present invention, as the value of the download mode information, the user selection mode and the manufacturer selection mode are further provided, in addition to the default mode and the monitor application selection mode.

If the download mode information is the user selection mode, the host 430 asks the user about whether or not the download of the software is started when the software download code information is received, and determines whether or not the download of the software is started according to the response of the user. That is, if the user wants to immediately perform the download, the host 430 immediately starts the download of the software and, if the user wants to perform the download later, the host 430 starts the download of the software later. If the download of the software is completed, the host 430 asks the user about whether or not rebooting is performed and determines whether or not the rebooting is performed according to the response of the user. That is, when the user wants to perform the rebooting immediately, the host 430 is rebooted and, when the user wants to perform the rebooting later, the host 430 is rebooted later. Therefore, since an opportunity to select a download start time point can be provided to the user, it is possible to prevent the viewing of the broadcast of the user from being interrupted due to the download of the software. In addition, the downloaded software can be installed at a desired time of the user and the existing software can be updated using the downloaded software code.

If the download mode information is the manufacturer selection mode, the host 430 determines whether or not the download of the software is started using a manufacturer application. In this case, since the manufacturer application checks the characteristics of the receiver, such as the number of tuners or the number of decoders and the number of tuners and decoders which are not used in the current receiver, it may be determined whether or not the download of the software is started according to the characteristics and the current status of the specific broadcast receiver based on the checked result. For example, if it is determined that all the tuners and decoders are currently used in the viewing or recording of a program, the manufacturer application may determine that the download of the software is started later or allow the user to select whether or not the download of the software is started, as in the user selection mode. In contrast, if it is determined that the tuner and decoder are not in use, the manufacturer application may start the download of the software. In this case, the host 430 can download new software using the redundant tuner and decoder without interrupting the viewing of the program of the user. The user may be informed of the downloading process via a small message window or the software may be downloaded without informing the user. If the download of the software is completed, the host 430 asks the user about whether or not rebooting is performed and determines whether or not the rebooting is performed according to the response of the user. That is, if the user wants to immediately perform the rebooting, the host 430 immediately performs the rebooting and, if the user wants to perform the rebooting later, the host 430 performs the rebooting later.

When the cable headend 410 transmits the software download code information via the cable, the cable card 420 receives the transmitted software download code information. In addition, if the received software download code information is associated with the host 430 in which the cable card is mounted, the cable card 420 filters the received software download code information (421) such that the host 430 receives the software download code information.

When the host 430 receives the software download code (code_version_table) from the cable card 420 and transmits a reception reply (code_version_table_reply), the host 430 may receive a software code block (DSM-CC data download formatted code file).

The host 430 can obtain reception locator information of the software or the version of the software code to be downloaded from the software download code information filtered by the cable card 420.

The host 430 may tune to a frequency (431), open a specific channel based on the reception locator information of the software (432), and receive a software code block (DSM-CC data download formatted code file from the opened specific channel.

The software code block may be transmitted by the DDB message described with reference to FIGS. 2 and 3. The host 430 may transmit download control information (host_download_control) indicating the start and the end of the reception of the software code block to the cable card 420.

Thereafter, when the information indicating the start and the end of the reception of the software code block is received from the host 430, the cable card 420 may inform the headend 410 of that information.

If the cable card 420 transmits information indicating that the reception of the whole software code block has failed to the cable headend 410, the cable headend 410 may retransmit the software code block such that the host 430 receives the software code block.

Alternatively, if the host 430 does not complete the reception of the software code block within a predetermined time, the reception of the whole code block is retried. If the reception fails in spite of a predetermined number of retrials, the cable card 420 may send information indicating that the reception has failed to the headend 410.

When the host 430 receives the whole software code block, download control information indicating whether or not the reception is completed may be retransmitted to the cable card 420.

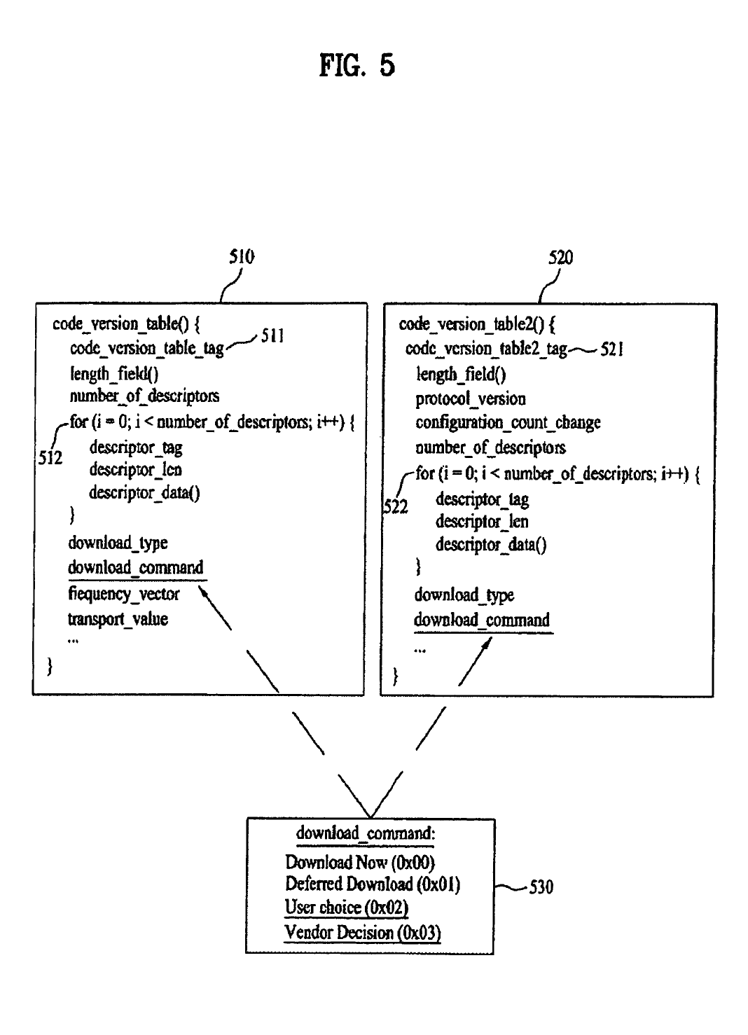

FIG. 5 is a view showing an exemplary embodiment of a Code Version Table (CVT).

Referring to FIG. 5, hereinafter, the CVT is used as an example of software download code information available in a cable broadcast system. The CVT is an example of data associated with software reception code information including the manufacturer of the host 430 or the hardware version thereof. The CVT may include information such as a media access control (MAC) address of the host 430 or an identifier (ID) of the host 430.

The CVT is divided into a CVT 510 including a code_version_table_tag 511 and a CVT2 520 including a code_version_table2_tag 521. In each of the CVT 510 and the CVT2 520, a descriptor_tag, a descriptor_len and a descriptor_data( ) may be set according to the number of descriptors (512 and 522).

The CVT 510 and the CVT 520 may correspond one-to-one to the hardware version of the host 430 using the values of the descriptor_tag and the descriptor_data( ). For example, if the descriptor_tag is 0x00, the descriptor_data( ) may indicate a vendor_id and, if the descriptor_tag is 0x01, the descriptor_data( ) may indicate a hardware_version_id.

The vendor_id indicates the manufacturer of the host 430, and the hardware_version_id indicates the hardware version of the host 430. If the descriptor_tag is 0x02, the descriptor_data( ) may indicate a host_MAC_address and, if the descriptor_tag is 0x03, the descriptor_data( ) may indicate a host_ID.

When the host receives the CVT 510 or the CVT2 520, the host 430 reads the value of a download_type and a download_command. The host 430 determines the download mode based on the read value of the download_command. The value of the download_command is one example of the download mode information, and the download_command 530 may be set to any one of Download Now (0x00), Deferred Download (0x01), User Choice (0x02) and Vendor Decision (0x03). Download Now (0x00), Deferred Download (0x01), User Choice (0x02) and Vendor Decision (0x03) correspond to the default mode, the monitor application selection mode, the user selection mode and the manufacturer selection mode, respectively.

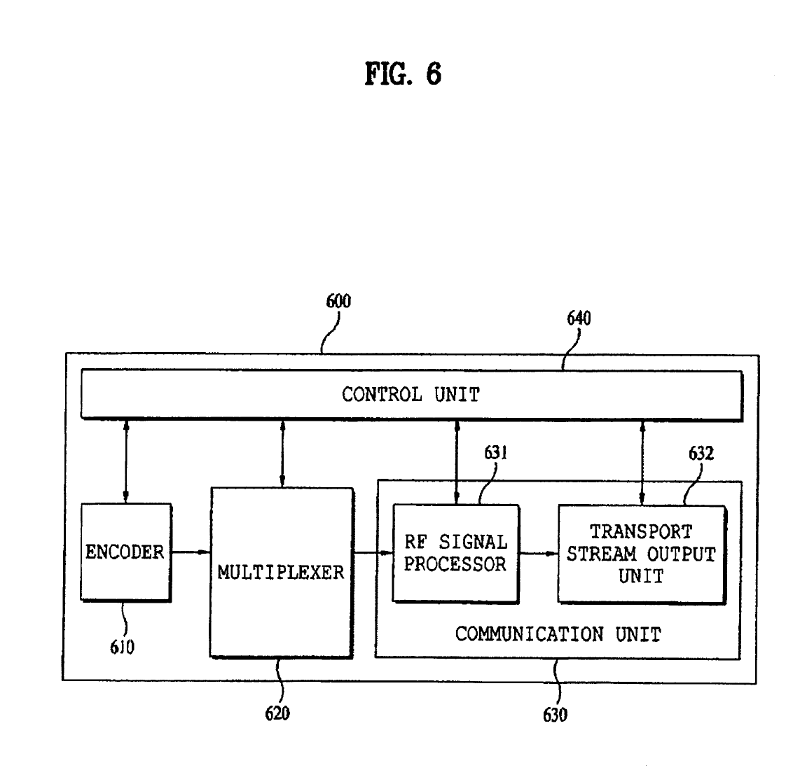

FIG. 6 is a block diagram showing the configuration of an exemplary embodiment of a broadcast transmitter according to the present invention.

Referring to FIG. 6, the broadcast transmitter according to the present invention includes an encoder 610, a multiplexer 620, a communication unit 630 and a control unit 640.

The encoder 610 encodes data and may include a video encoder and an audio encoder. The video encoder encodes video data, and generates and provides a video stream to the multiplexer 620. The audio decoder encodes audio data, and generates and provides an audio stream to the multiplexer 620.

The multiplexer 620 multiplexes the streams encoded by the encoder 610, and generates and sends one or a plurality of transport streams to the communication unit 630.

The communication unit 620 transmits the transport stream generated by the multiplexer 620, and includes a radio frequency (RF) signal processor 631 and a transport stream output unit 632. The RF signal processor 631 modulates the transport stream generated by the multiplexer 620 to an output signal and sends the output signal to the transport stream output unit 632. The transport stream output unit 632 transmits the modulated transport stream received from the RF signal processor 631.

The control unit 640 controls the operations of the units and generates an object carousel message such as a DSI message, a DII message and a DDB message to be carried on the transport stream. In addition, the control unit 640 selects any one of the default mode, the monitor application selection mode, the user selection mode and the manufacturer selection mode as the download mode information, includes the selected download mode information in the software download code information so as to generate download code information, and controls to transmit the generated download code information in a state of being carried on the transport stream. That is, the communication unit 630 transmits the software download code information generated by the control unit 640.

The control unit 640 may generate the CVT as the software download code information. In this case, the control unit 640 may set the value of the download_command 530 to any one of Download Now (0x00), Deferred Download (0x01), User Choice (0x02) and Vendor Decision (0x03).

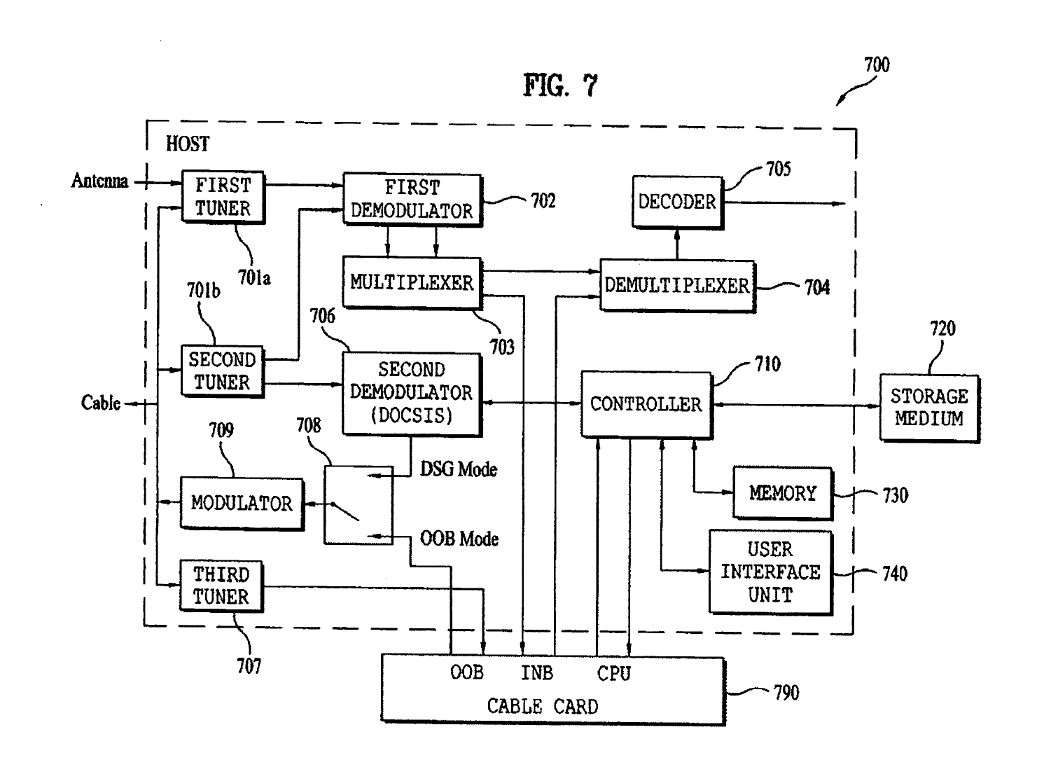

FIG. 7 is a block diagram showing the configuration of an exemplary embodiment of a broadcast receiver according to the present invention.

Referring to FIG. 7, the cable broadcast receiver 700 includes a host 750 and a cable card 790. The cable card 790 may be detachably connected to the host 750 and is one of a single (S)-card for processing a single stream and a multi (M)-card for processing multiple streams.

The host 750 may receive only a cable broadcast or at least one digital broadcast of a cable broadcast, a terrestrial broadcast and a satellite broadcast. The host 750 includes a first tuner 701a, a second tuner 701b, a first demodulator 702, a multiplexer 703, a demultiplexer 704, a decoder 705, a second demodulator (DOCSIS) 706, a third tuner 707, a switch 708, a modulator 709, a controller 710, a storage medium 720, a memory 730, and a user interface unit 740.

A bi-directional communication mode between a cable broadcast receiver 700 and a headend includes two modes: an OOB mode and a DSG mode. Accordingly, a viewer may select and view a desired program via the host 750 using any one of the OOB mode and the DSG mode. Alternatively, the viewer may directly participate in a broadcast program or select and view necessary information. A data broadcast service may be provided using the OOB mode and/or the DSG mode.

The first tuner 701a tunes to only a specific channel frequency of a cable audio/video (A/V) broadcast transmitted in-band via a cable or a terrestrial A/V broadcast transmitted via an antenna, and outputs the tuned signal to the first modulator 702.

Since the terrestrial broadcast and the cable broadcast are different from each other in terms of transport method, the first demodulator 702 can perform different demodulating methods with respect to the signals transmitted by different transport methods. For example, the terrestrial A/V broadcast transmitted in a state of being modulated by a Vestigial Sideband Modulation (VSB) mode is demodulated in an inverse manner to the VSB mode. The cable A/V broadcast transmitted in a state of being modulated by a Quadrature Amplitude Modulation (QAM) mode is demodulated in an inverse manner to the QAM mode.

The signal demodulated by the first demodulator 702 is multiplexed by the multiplexer 703 to output a stream. At this time, if a plurality of in-band tuners for receiving the cable A/V broadcast is included and different channels are simultaneously tuned by the in-band tuners and are demodulated by respective demodulators to output multiple streams, the multiple streams are multiplexed by the multiplexer 703 to output the multiplexed signal.

If the signal demodulated by the first demodulator 702 is a terrestrial broadcast stream, the demodulated stream is output to the demultiplexer 704 via the multiplexer 703. In contrast, if the signal demodulated by the first demodulator 702 is a cable broadcast stream, the demodulated stream is output to the demultiplexer 704 via the multiplexer 703 and the cable card 790 mounted in a slot. The cable card 790 includes a Conditional Access (CA) system for preventing illegal copying of high value-added broadcast content and restricting access to such content, and is also called a Point-Of-Deployment (POD) module.

That is, if the single stream or the multiple streams of the cable broadcast output from the multiplexer 703 is scrambled, the cable card 790 descrambles the single stream or the multiple streams and outputs the descrambled stream to the demultiplexer 704. If the cable card 790 is not mounted, the signal stream or the multiple streams of the cable broadcasting signal demodulated by the first demodulator 702 is directly output to the demultiplexer 704. In this case, since the scrambled cable broadcast is not descrambled, the broadcast is not normally viewed.

The demultiplexer 704 demultiplexes the multiplexed broadcast stream into audio, video, and data streams, and outputs the streams to the decoder 705. The decoder 705 may include an audio decoder, a video decoder, and a data decoder. That is, the audio stream demultiplexed by the demultiplexer 704 is decoded by the audio decoder, the video stream is decoded by the video decoder, and the data stream is decoded by the data decoder.

The second tuner 701b tunes to a specific channel frequency of the data broadcast transmitted via the cable in the DSG mode and outputs the tuned signal to the second demodulator 706. The second demodulator 706 demodulates the data broadcast of the DSG mode and outputs the demodulated broadcast signal to the controller 710.

The third tuner 707 tunes to a specific channel frequency of a downlink data broadcast transmitted via the cable in the OOB mode and outputs the tuned signal to the cable card 790. That is, the third tuner 707 receives software download code information and software transmitted by the broadcast transmitter 600 and outputs the received information and software to the cable card 790. The cable card 790 filters the software download code information and sends the software download code information associated with the cable broadcast receiver 700 to the controller 710.

If bi-directional communication between the headend and the broadcast receiver is possible, uplink information (e.g. hardware and software information of the host, pay program application, diagnostic information of the host, or the like) transmitted from the broadcast receiver 700 to the headend may be transmitted in the OOB mode or the DSG mode. Accordingly, the embodiment of the cable broadcast receiver according to the present invention may include the switch 708 so as to select any one of the modes and transmit the information. For example, the host_online_notification is transmitted to the headend 410 via the switch 708 in the OOB mode.

In the OOB mode, hardware and software information of the host, user information or system diagnostic information is output to the modulator 709 via the cable card 790 and the switch 708, and the modulator 709 modulates the output signal using a QPSK modulation mode and transmits the modulated signal to the headend via the cable. If the broadcast information of the user is transmitted in the DSG mode, the broadcast information of the user is output to the modulator 709 via the controller 710 and the switch 708 and is modulated by the modulator 709 using a QAM-16 modulation mode, and the modulated signal is transmitted to the headend via the cable.

The controller 710 determines a download mode based on the download mode information included in the software download code information delivered by the cable card 790.

If the download mode is the user selection mode, the controller 710 controls the download of the software according to a download selection command received by the user interface unit 740. That is, the controller 710 outputs a guide message to ask the user about whether or not the download of the software is started to the user interface unit 740. The guide message may be, for example, a message or a window including a guide message “New software is available. Do you wish to download the software now? The current broadcast will be interrupted if no unused tuner or decoder is available.” and a button for selecting “Yes” or “No”. If the user selects a button “No” as the download selection command, the controller 710 maintains a normal broadcast viewing status without starting a software download process. If the user selects the button “Yes” as the download selection command, the controller 710 controls the tuner and the decoder, and downloads and stores the software in the memory 730.

If the download of the software is completed, the controller 710 determines whether or not rebooting is performed based on a rebooting selection command received by the user interface unit 740. First, the controller 710 outputs the guide message to ask the user about whether or not the rebooting is performed to the user interface unit 740. The guide message may be, for example, a message or a window including a guide message “The download of new software is completed. Would you like to restart the receiver now?” and a button for allowing the user to select “Yes” or “No”. If the user selects the button “Yes” as the rebooting selection command, the controller 710 performs a rebooting process. If the user selects the button “No” as the rebooting selection command, the controller 710 returns to the normal broadcast viewing status without rebooting. At this time, the downloaded software is stored in the memory 730, and then is installed, updated or executed when the user turns on the broadcast receiver after the viewing of the broadcast is completed and the broadcast receiver is turned off.

If the download mode is the manufacturer selection mode, the controller 710 controls the manufacturer application to determine whether or not the download of the software is started. The manufacturer application checks the characteristics of the receiver such as the number of tuners and the number of decoders, and the number of tuners and decoders which are not used in the current receiver, and determines whether or not the download of the software is started according to the characteristics and the current status of the cable broadcast receiver 700 based on the checked result. If the download of the software is started and completed according to the determination of the manufacturer application, the controller 710 determines whether or not rebooting is performed based on the rebooting selection command received by the user interface unit 740. First, the controller 710 outputs a guide message to ask the user about whether or not rebooting is performed to the user interface unit 740. The guide message may be, for example, a message or a window including a guide message “The download of new software is completed. Would you like to restart the receiver now?” and a button for allowing the user to select “Yes” or “No”. If the user selects the button “Yes” as the rebooting selection command, the controller 710 performs a rebooting process. If the user selects the button “No” as the rebooting selection command, the controller 710 returns to the normal broadcast viewing status without rebooting. At this time, the downloaded software is stored in the memory 730, and then is installed, updated or executed when the user turns on the broadcast receiver after the viewing of the broadcast is completed and the broadcast receiver is turned off.

The controller 710 may perform a DVR function using the storage medium 720 as a repository. That is, the controller 710 may function as a Personal Video Recorder (PVR) based on the storage medium 720 and store recorded content in the storage medium 720. In addition, the controller 710 may set a “time-shift buffer” in the storage medium 720 in order to perform a time shift function. The storage medium 720 may be mounted in the cable broadcast receiver 700, may be an external storage medium 720 connected to a universal serial bus (USB) port, or may be a storage medium which is internally or externally mounted in an information communication device via a data network in an IEEE802.11 communication scheme, an IEEE802.11n communication scheme, an IEEE802.11g communication scheme, an IEEE802.15.4 communication scheme, a Wi_Fi communication scheme, an Ethernet communication scheme, a WCDMA communication scheme or a GRS communication scheme.

The operation of the controller 710 may be performed by any one of hardware, firmware, middleware and software or a combination of at least two thereof. A computer-readable code for executing an application, middleware and an operating system and other necessary data or information are stored in the memory 730. In addition, the controller 710 may store the software downloaded from the headend 410 in the memory 730. The application, the middleware and the operating system are executed according to the requirements of the user or another application when the power of the cable broadcast receiver is turned on.

The user interface unit 740 displays information or a command and receives information and a command from the user. The user interface unit 740 may include an on screen display (OSD) generator for generating and outputting an OSD image in order to display the information or the command, and may include a remote controller receiver in order to receive the information or the command from the user. The user may view a screen on which the OSD image is displayed, check the information or the command, and input the information or the command to the cable broadcast receiver 700 using a remote controller.

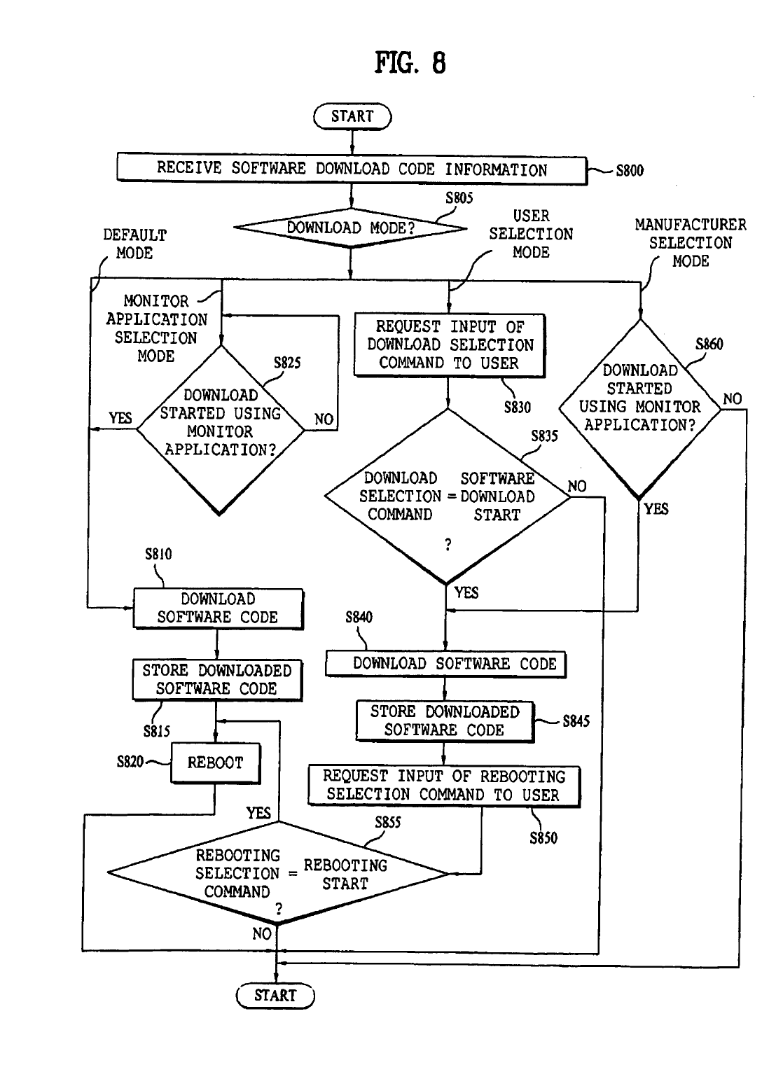

FIG. 8 is a flowchart illustrating an exemplary embodiment of a method of receiving software of a broadcast receiver according to the present invention.

Referring to FIG. 8, the third tuner 707 receives software download code information (S800). The controller 710 determines a software download mode based on download mode information included in the software download code information received by the third tuner 707 (S805).

If the download mode information is a default mode, the controller 710 adjusts the channel of the first tuner 701a or the second tuner 701b based on the software download code information and downloads a software code from the broadcast transmitter 600 (S810). The controller 710 stores the downloaded software code in the memory 730 (S815). If the download is completed, the controller 710 reboots the cable broadcast receiver 700 (S820).

If the download mode information is a monitor application selection mode, the controller 710 determines whether or not the download is started using the monitor application (S825).

If the download mode information is a user selection mode, the controller 710 requests the input of a download selection command to a user (S830). The controller 710 determines whether or not the download of the software is started based on the download selection command received from the user (S835).

If it is determined that the download of the software is started, the controller 710 adjusts the channel of the first tuner 701a or the second tuner 701b based on the software download code information and downloads the software code from the broadcast transmitter 600 (S840). The controller 710 stores the downloaded software code in the memory 730 (S845). If the download is completed, the controller 710 requests the input of a rebooting selection command to the user (S850). Then, the controller 710 may determine whether or not rebooting is performed based on the rebooting selection command received from the user (S855).

If it is determined that the rebooting is started, the controller 710 reboots the cable broadcast receiver 700 in order to install software or upgrade the existing software with the downloaded software code (S820).

If the download mode information is the manufacturer selection mode, the controller 710 determines whether or not the download of the software is started using the manufacturer application (S860).

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of receiving software of a broadcast receiver, the method comprising:
receiving software download code information;
checking a software download mode based on download mode information included in the received software download code information;
requesting input of a download selection command to a user if the download mode information is a user selection mode; and
determining whether or not the download of the software is started based on the download selection command received from the user.

2. The method according to claim 1, further comprising determining whether or not the download of the software is started using a manufacturer application if the download mode information is a manufacturer selection mode.

3. The method according to claim 2, wherein the manufacturer application determines whether or not the download of the software is started based on at least one of the number of available tuners and the number of available decoders.

4. The method according to claim 1, further comprising receiving the software based on the software download code information if it is determined that the download of the software is started.

5. The method according to claim 4, wherein the receiving of the software includes receiving the software based on reception locator information included in the software download code information.

6. The method according to claim 4, wherein the receiving of the software includes receiving the software in the form of a Digital Storage Media Command and Control (DSM-CC) data download formatted code file.

7. The method according to claim 4, further comprising:
requesting the input of a rebooting selection command to the user if the reception of the software is completed; and
determining whether or not rebooting is performed based on the rebooting selection command received from the user.

8. The method according to claim 1, wherein the software download code information includes at least one of manufacturer information and hardware information.

9. The method according to claim 1, wherein the software download code information is transmitted in the form of a Code Version Table (CVT).

10. The method according to claim 9, wherein the CVT includes a descriptor field including hardware version information of a host, a descriptor number field including information about the number of descriptors, and a download command field including the download mode information.

11. A broadcast receiver comprising:
a tuner receiving software download code information;
a user interface unit displaying information or a command and receiving information or a command from a user; and
a controller checking a download mode based on download mode information included in the received software download code information and controlling the download of software according to a download selection command received by the user interface unit if the checked download mode is a user selection mode.

12. The broadcast receiver according to claim 11, wherein the controller controls a manufacturer application to determine whether or not the download of the software is started if the checked download mode is a manufacturer selection mode.

13. The broadcast receiver according to claim 12, wherein the manufacturer application determines whether or not the download of the software is started based on at least one of the number of available tuners and the number of available decoders.

14. The broadcast receiver according to claim 11, wherein the controller determines whether or not rebooting is performed based on a rebooting selection command received by the user interface unit if the download of the software is completed.

15. The broadcast receiver according to claim 11, wherein the software download code information includes at least one of manufacturer information and hardware information.

16. The broadcast receiver according to claim 11, wherein the software download code information is transmitted in the form of a Code Version Table (CVT).

17. The broadcast receiver according to claim 16, wherein the CVT includes a descriptor field including hardware version information of a host, a descriptor number field including information about the number of descriptors, and a download command field including the download mode information.

18. A broadcast transmitter comprising:
a controller selecting any one of a default mode, a monitor application selection mode, a user selection mode and a manufacturer selection mode as download mode information and including the selected download mode information in software download code information; and
a communication unit transmitting the software download code information.

19. The broadcast transmitter according to claim 18, wherein the software download code information includes at least one of manufacturer information and hardware information of a broadcast receiver.

20. The broadcast transmitter according to claim 18, wherein the controller controls the software download code information to be included in a Code Version Table (CVT) and controls the CVT to be transmitted.
